(19) United States
(12) Patent Application Publication
(10) Pub. No.: US 2017/0357928 A1
(43) Pub. Date: Dec. 14, 2017

(54) SYSTEM AND METHOD FOR INDUSTRIAL PROCESS CONTROL AND AUTOMATION SYSTEM OPERATOR EVALUATION AND TRAINING

(71) Applicant: Honeywell International Inc., Morris Plains, NJ (US)

(72) Inventors: Martin Ross, Woking (GB); John J. Roffel, Strathroy (CA); Michael W. Brown, Edmonton (CA); Andrew John Trenchard, Romsey (GB)

(21) Appl. No.: 15/493,693

(22) Filed: Apr. 21, 2017

Related U.S. Application Data
(60) Provisional application No. 62/347,352, filed on Jun. 8, 2016.

(51) Int. Cl. G06Q 10/06; G09B 9/00; G09B 5/02; G09B 19/00; G09B 7/00; G09B 5/04; G05B 19/418

(52) U.S. Cl. CPC G06Q 10/06398; G06Q 10/067; G09B 7/00; G09B 9/00; G09B 5/04; G09B 5/02; G09B 19/00; G05B 2219/25419; G05B 19/41865

(57) ABSTRACT

A method includes obtaining at least one model associating areas of competency with job roles and job responsibilities of personnel, the at least one model also associating the areas of competency with curricula of training exercises and content. The method also includes obtaining a library of intervention assets associated with the areas of competency, the intervention assets comprising content for training personnel in at least one of the areas of competency. The method further includes evaluating a trainee to determine a competency gap analysis of the trainee, the competency gap analysis comprising a competency gap associated with job responsibilities of the trainee, the competency gap identifying at least one of the areas of competency in which the trainee requires training. In addition, the method includes providing web-based training to the trainee based on the competency gap, the training comprising at least one intervention asset and at least one intervention activity.

### CROSS-REFERENCE TO RELATED APPLICATION AND PRIORITY CLAIM

This application claims priority under 35 U.S.C. §119(e) to U.S. Provisional Patent Application No. 62/347,352 filed on Jun. 8, 2016 and entitled “SYSTEM AND METHOD FOR INDUSTRIAL PROCESS CONTROL AND AUTOMATION SYSTEM OPERATOR EVALUATION AND TRAINING,” the content of which is hereby incorporated by reference in its entirety.

### TECHNICAL FIELD

This disclosure relates generally to industrial process control and automation. More specifically, this disclosure relates to a system and method for industrial process control and automation system operator evaluation and training.

### BACKGROUND

Industrial process control and automation systems are often used to automate and operate large and complex industrial processes. These types of systems routinely include sensors, actuators, and controllers. The controllers are often arranged hierarchically in a control and automation system. For example, lower-level controllers are often used to receive measurements from the sensors and perform process control operations to generate control signals for the actuators. Higher-level controllers are often used to perform higher-level functions, such as planning, scheduling, and optimization operations. Human operators routinely interact with controllers and other devices in a control and automation system, such as to review warnings, alarms, or other notifications associated with various events and make adjustments to control or other operations.

### SUMMARY

This disclosure provides a system and method for industrial process control and automation system operator evaluation and training.

In a first embodiment, a method includes obtaining at least one model associating areas of competency with job roles and job responsibilities of personnel, the at least one model also associating the areas of competency with curricula of training exercises and content. The method also includes obtaining a library of intervention assets associated with the areas of competency, the intervention assets comprising content for training personnel in at least one of the areas of competency as part of the curricula of training exercises and content. The method further includes evaluating a trainee, by a competency management system, to determine a competency gap analysis of the trainee, the competency gap analysis comprising at least one competency gap associated with job responsibilities of the trainee, the at least one competency gap identifying at least one of the areas of competency in which the trainee requires training. In addition, the method includes providing, by a training system, web-based training to the trainee based on the at least one competency gap, the training comprising at least one of the intervention assets and at least one intervention activity.

In a second embodiment, an apparatus includes at least one interface and at least one processing device. The at least one interface is configured to exchange information over a cloud-based network. The at least one processing device is configured to obtain at least one model associating areas of competency with job roles and job responsibilities of personnel, the at least one model also associating the areas of competency with curricula of training exercises and content. The at least one processing device is also configured to obtain a library of intervention assets associated with the areas of competency, the intervention assets comprising content for training personnel in at least one of the areas of competency as part of the curricula of training exercises and content. The at least one processing device is further configured to control a competency management system to evaluate a trainee in order to determine a competency gap analysis of the trainee, the competency gap analysis comprising at least one competency gap associated with job responsibilities of the trainee, the at least one competency gap identifying at least one of the areas of competency in which the trainee requires training. In addition, the at least one processing device is configured to control a training system to provide web-based training to the trainee based on the at least one competency gap, the training comprising at least one of the intervention assets and at least one intervention activity.

In a third embodiment, a non-transitory computer readable medium contains instructions that, when executed by at least one processing device, cause the at least one processing device to obtain at least one model associating areas of competency with job roles and job responsibilities of personnel, the at least one model also associating the areas of competency with curricula of training exercises and content. The medium also contains instructions that, when executed by the at least one processing device, cause the at least one processing device to obtain a library of intervention assets associated with the areas of competency, the intervention assets comprising content for training personnel in at least one of the areas of competency as part of the curricula of training exercises and content. The medium further contains instructions that, when executed by the at least one processing device, cause the at least one processing device to control a competency management system to evaluate a trainee in order to determine a competency gap analysis of the trainee, the competency gap analysis comprising at least one competency gap associated with job responsibilities of the trainee, the at least one competency gap identifying at least one of the areas of competency in which the trainee requires training. In addition, the medium contains instructions that, when executed by the at least one processing device, cause the at least one processing device to control a training system to provide web-based training to the trainee based on the at least one competency gap, the training comprising at least one of the intervention assets and at least one intervention activity.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIGS. 2 through 5 illustrate an example system for industrial process control and automation system operator evaluation and training according to this disclosure;

FIG. 6 illustrates an example method for industrial process control and automation system operator evaluation and training according to this disclosure; and

FIG. 7 illustrates an example device supporting industrial process control and automation system operator evaluation and training according to this disclosure.

### DETAILED DESCRIPTION

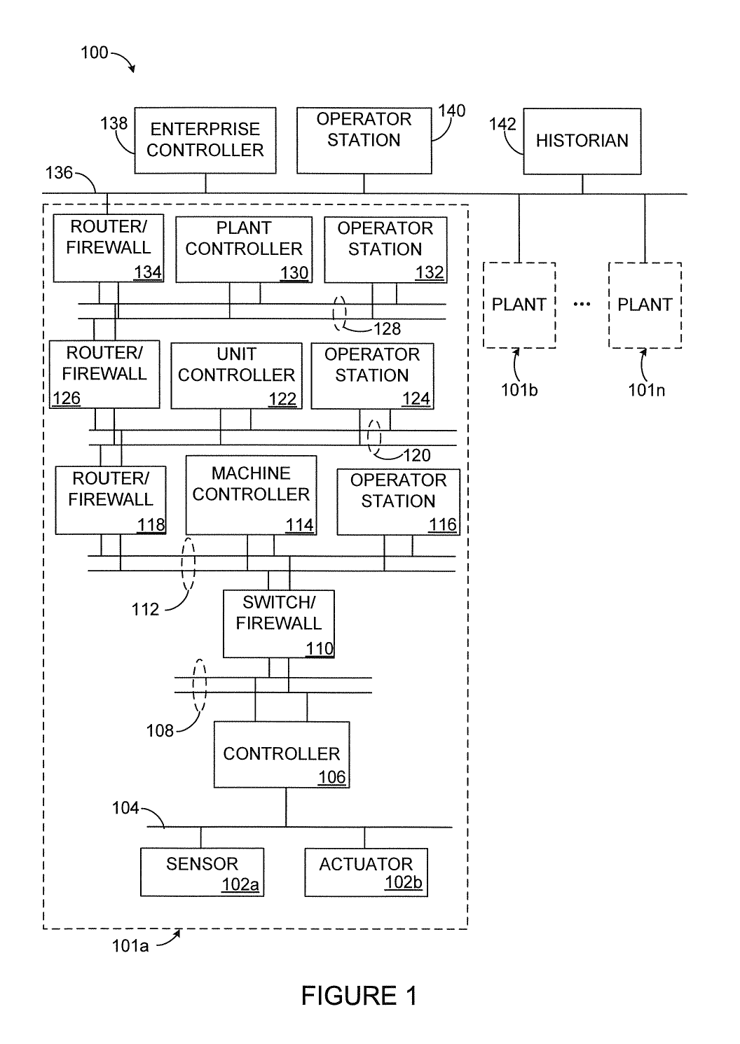

FIGS. 1 through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

As described above, human operators routinely interact with controllers and other devices in an industrial process control and automation system, such as to review warnings, alarms, or other notifications associated with various events and make adjustments to control or other operations. Errors by human operators can have negative economic, safety, or other consequences to the owners of an industrial facility and potentially to the general public. Owners of industrial facilities therefore typically require or desire competent staff to operate the industrial facilities and their associated equipment. Owners are financially incentivized (and in some cases mandated) to employ operators with the appropriate skill levels and knowledge for safe and efficient execution of process operations.

Operator evaluations and training simulators are often deployed as effective training tools by companies wishing to develop operator competency. However, research has identified that many companies lack an effective process for deploying training interventions, including simulator-based training. Typical issues observed are that interventions are not competency-based and that feedback is weak and not timely.

To address these and other issues, embodiments of this disclosure provide web-based or cloud-hosted course curricula that are competency-based and provide clear and timely feedback to trainees. The combination of interventions and course structure is designed to address problems such as a lack of design and feedback, thereby providing a superior training outcome.

In some embodiments, a trainee can be trained in a particular set of competencies using the web-based or cloud-hosted system. Rather than have to go to multiple locations to receive training (possibly from multiple vendors), the trainee can access the training from his or her workstation. Simulations can be performed or executed at the workstation, rather than in another location. In some embodiments, the competencies are developed based on (or in accordance with) the Abnormal Situation Management (ASM) Consortium. The ASM Consortium has developed a competency framework for defining competencies for roles that are relevant in industrial process and control systems. Additionally or alternatively, the competencies can be developed based on (or in accordance with) other competency models. In general, the disclosed embodiments are flexible and can accommodate one or multiple different competency models.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

One or more networks 104 are coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” includes one or more controllers 106, which are coupled to the network 104. Among other things, each controller 106 may use the measurements from one or more sensors 102a to control the operation of one or more actuators 102b. Each controller 106 includes any suitable structure for controlling one or more aspects of a process system. As a particular example, each controller 106 could represent a computing device running a real-time operating system.

Redundant networks 108 are coupled to the controllers 106. The networks 108 facilitate interaction with the controllers 106, such as by transporting data to and from the controllers 106. The networks 108 could represent any suitable redundant networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an H E network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

A historian 142 is also coupled to the network 136 in this example. The historian 142 could represent a component that stores various information about the system 100. The historian 142 could, for example, store information used during production scheduling and optimization. The historian 142 represents any suitable structure for storing and facilitating retrieval of information. Although shown as a single centralized component coupled to the network 136, the historian 142 could be located elsewhere in the system 100, or multiple historians could be distributed in different locations in the system 100.

Operators may use various devices (such as various operator stations described above) to oversee, control, and adjust operations of other devices (such as various controllers described above) in the system 100. Operators may also use various devices to review warnings, alarms, or other notifications associated with the system 100 and take corrective action. As a result, evaluating the competencies of the operators and providing training to improve the competencies of the operators can be extremely important or even required. The description below describes how industrial process control and automation system operator evaluation and training can be supported.

Although FIG. 1 illustrates one example of an industrial process control and automation system 100, various changes may be made to FIG. 1. For example, industrial control and automation systems come in a wide variety of configurations. The system 100 shown in FIG. 1 is meant to illustrate one example operational environment in which industrial process control and automation system operator evaluation and training may be needed or desired. However, FIG. 1 does not limit this disclosure to any particular configuration or operational environment.

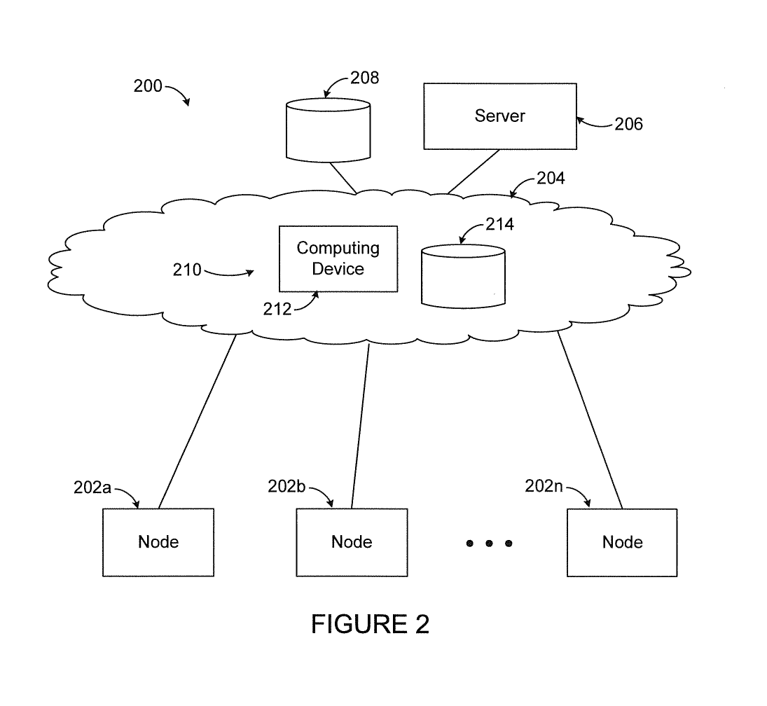

FIGS. 2 through 5 illustrate an example system for industrial process control and automation system operator evaluation and training according to this disclosure. As shown in FIG. 2, a system 200 includes a number of computing nodes 202a-202n. The computing nodes 202a-202n denote any suitable computing or communication devices that can be used by operators or other personnel. The computing nodes 202a-202n could, for instance, denote desktop computers, laptop computers, tablet computers, or mobile smartphones. The computing nodes 202a-202n could be used by various personnel, such as operators or other personnel requiring or desiring training related to an industrial process control and automation system, such as the system 100 of FIG. 1.

The computing nodes 202a-202n are coupled to at least one network 204. The network 204 facilitates interaction and exchange of data involving the computing nodes 202a-202n. For example, data transmitted by or received at any of the computing nodes 202a-202n may pass through the network 204. The network 204 denotes any suitable network or combination of networks, such as one or more local area networks, metropolitan area networks, wide area networks, or global networks such as the Internet.

Operator evaluation and training could be provided in various ways in FIG. 2. For example, in some embodiments, the operator evaluation and training to could be supported by one or more servers 206 or other standalone computing devices. Each server 206 could include one or more processing devices, one or more memories, and one or more interfaces. Each processing device includes any suitable processing or computing device, such as a microprocessor, microcontroller, digital signal processor, field programmable gate array, application specific integrated circuit, or discrete logic devices. Each memory includes any suitable storage and retrieval device, such as random access memory (RAM), Flash memory, or read only memory (ROM). Each interface includes any suitable structure facilitating communication over a connection or network, such as a wired interface (like an Ethernet interface) or a wireless interface (like a radio frequency transceiver). At least one database 208 could be coupled to the network 204 or otherwise be accessible to the server(s) 206. Each database 208 could store any suitable information associated with operator evaluation and training in any suitable format.

In other embodiments, operator evaluation and training could be supported within a network-based environment 210, such as a computing cloud. The network-based environment 210 could include various components that support cloud-based operator evaluation and training. For example, the network-based environment 210 could include one or more servers or other computing devices 212 that execute logic supporting operator evaluation and training, as well as one or more databases 214 that store data used for operator evaluation and training. As is typical with computing clouds, the specific device or devices executing the logic and storing the data can change over time, such as when different servers are selected at different times for executing the logic based on load balancing or other factors.

The use of a cloud environment can provide a number of technical advantages over non-cloud based environments. For example, a cloud environment allows the system 200 to be easily scaled up or down to provide resources of an appropriate scale to accommodate changing training needs. For example, if an enterprise acquires or builds new industrial plants that are staffed by additional operators, the system 200 could be expanded easily to accommodate additional training needs by adding one or more computing devices 212, databases 208, 214, or servers 206. Similarly, if training needs are reduced, various components of the computing cloud could be eliminated or downsized.

However implemented, the operator evaluation and training functionality of the system 200 allows administrators or other users to prepare a library of simulations, supporting materials, and applications (referred to as “content”) and bundle this content into an offering (referred to as a “curriculum”). In some embodiments, the content could be accessible to trainees via standard web browsers. A curriculum is used as a tool for management and review of competency development for each trainee. In some embodiments, the trainees may be operators or other personnel associated with an industrial process control and automation system, such as the system 100 of FIG. 1.

The use of training and evaluation content that is accessible from a web browser provides a number of technical advantages over manual, paper, and even single computer-based systems. For example, since the content is accessible via a standard web browser, a trainee could access training and evaluation content from anywhere in the world, as long as the trainee has an Internet connection. This allows great flexibility in providing training quickly and efficiently to geographically dispersed user groups. This also allows the components of the computing cloud to be substantially centralized, which can provide efficiencies in managing the system 200. Further, the computing device executing a standard web browser typically does not require any training or evaluation licenses, software, or hardware to be installed locally in order to provide a training environment to the trainee. In addition, the computing device is not required to be connected to a corporate computing network in order to provide training.

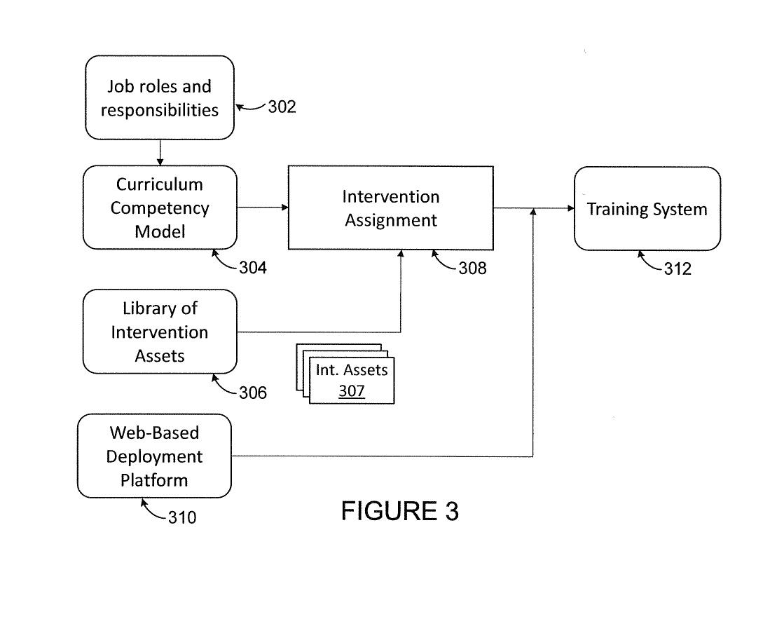

FIG. 3 illustrates an example functional overview of the system 200 shown in FIG. 2. The functional components in FIG. 3 could be executed or otherwise supported using the server 206 and database 208, the network-based environment 210, or in any other suitable manner. As shown in FIG. 3, the system 200 receives or accesses information 302 defining various job roles and responsibilities of personnel associated with at least one industrial process control and automation system. The information 302 could be provided by owners or operators of a control and automation system, standards bodies, industry or government regulatory agencies, or other source(s).

The information 302 is used to create at least one competency model 304, which defines at least one curriculum of training exercises and content for trainees. Each competency model 304 could include any suitable information for defining the areas of competency needed in various job roles and the curricula of training exercises and content for those areas of competency. Details of example competency models and how competency models may be used can be found in U.S. Patent Application Publication No. 2011/0307301 and U.S. Patent Application Publication No. 2014/0349255, the contents of which are incorporated by reference herein.

The system 200 also receives or has access to at least one library 306 of intervention assets 307. The intervention assets 307 denote simulations, supporting materials, applications, or other content that can be used to measure trainees' competence at delivering various outcomes or that can be used to provide training related to the outcomes. As a particular example, an intervention asset 307 could include a process model that simulates a process or operation within an industrial process and control system (such as a distillation process or a slide valve operation in a refinery). As another particular example, an intervention asset 207 could include a business ethics course or an environmental compliance course. Each library 306 could include information from any suitable source(s), such as personnel associated with an industrial process control and automation system or a third-party who provides training materials or other materials.

At least one intervention assignment function 308 uses the competency model or models 304 and the library or libraries 306 to map different intervention assets 307 to different job roles and responsibilities. The intervention assignment function 308 operates to identify which simulations, supporting materials, applications, or other content should be provided to different job roles and responsibilities in order to help increase operator competency. The intervention assignment function 308 could also analyze information associated with specific trainees to identify areas where the trainees require training.

In some cases, a newly-implemented training exercise could be required across multiple trainee groups. For example, certain training (such as business ethics) might be newly required for all or a large group of employees of an enterprise. Once the training exercise (such as a business ethics course) is added as an intervention asset 207, the intervention assignment function 308 could automatically map the new intervention asset 207 to all job roles and responsibilities. In some cases, training might be geographically based. For example, a business ethics course might be required only for employees in certain countries or regions in order to comply with local laws. In such cases, the intervention assignment function 308 can easily limit the mapping to job roles and responsibilities in only those countries or regions.

In this example, different ones of the intervention assets 307 can be provided to different trainees via a web-based deployment platform 310, which makes the intervention assets 307 available to at least one training system 312. The web-based deployment platform 310 includes any suitable logic for making content available via a web browser or other suitable interface. The training system 312 includes any suitable structure for providing content to trainees and obtaining information from the trainees. For example, the training system 312 can include a computer, laptop, or tablet having network access to the web-based deployment platform 310.

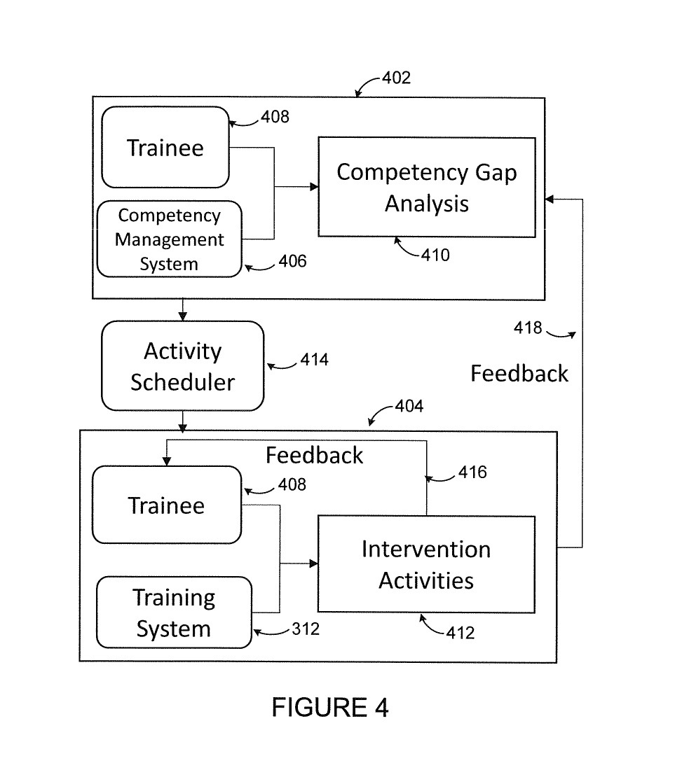

FIG. 4 illustrates example processes 402 and 404 that could occur in the system 200. The process 402 generally involves the use of a competency management system 406 to evaluate a trainee 408 and provide a competency gap analysis 410. The competency management system 406 could form part of the intervention assignment functionality of FIG. 3. The competency management system 406 operates to identify, for a trainee with a given job role and given job responsibilities, what competencies the trainee should possess. The competency management system 406 could also provide simulations (such as computer-based simulations of an industrial process), ask questions, receive responses or answers from the trainee in response to the simulations or questions, or otherwise attempt to identify what competencies the trainee actually possesses. Any differences in competencies can be used to generate the competency gap analysis 410, which identifies any gaps between the competencies that the trainee should possess and the competencies that the trainee actually possesses.

The process 404 generally involves the use of the training system 312 to provide training to a trainee 408, where the training involves one or more intervention activities 412. The intervention activities 412 could, for example, involve the use of various ones of the intervention assets 307 in the library 306. For example, the intervention activities 412 could involve providing the trainee 408 with audio or video content, running simulations to see how the trainee 408 reacts in certain situations, or replaying historical time series and event data for past abnormal situations together with lessons learned from those scenarios. In some cases, multiple intervention activities could be combined into one training exercise. For example, a simulation of a distillation process in a refinery could be combined with documentation to be read by the trainee, a video showing a distillation process expert to be watched by the trainee, and a quiz to be completed by the trainee.

An activity scheduler 414 could be used to schedule training as part of the process 404 based on the results of the process 402. For example, the activity scheduler 414 could analyze a competency gap analysis 410 for a trainee 408, identify the intervention activities 412 needed by the trainee 408, and schedule those intervention activities 412.

Multiple types of feedback can be provided as shown in FIG. 4. For example, feedback 416 generated through the use of the intervention activities 412 can be provided directly to the trainee 408. This could include, for example, the trainee 408 being informed of how the trainee 408 performed during a simulation. Because the training is computer-based and web-based, results of the trainee's performance can be obtained and processed by the training system 312 and provided directly and immediately to the trainee (such as when displayed on the web browser) in real time. This real-time feedback 416 to the trainee promotes understanding by the trainee and helps to ensure that the training is useful, beneficial, and relevant.

Feedback 418 generated through the use of the intervention activities 412 can also be provided to the process 402 so that the competency gap analysis 410 of the trainee 408 can be updated. This could include, for example, the process 402 receiving information indicating that the trainee 408 is no longer deficient in certain competencies.

The feedback 418 could also include information used for aggregate data collection or heuristics. For example, feedback 418 from multiple trainees could be collected and aggregated by the system 200 in order to determine benchmarks, training successes, and training progressions of populations of trainees. Such populations could be divided and compared based on years of experience, geographical location, job roles, demographics, or any other suitable characteristic(s). As a particular example, by aggregating feedback 418 from a large number of trainees over a period of time, it may be possible to determine that some types of training (such as simulations) are more effective or successful in one geographic region, while another type of training (such as quizzes) are more effective or successful in another region. A centralized, cloud-based system facilitates the rapid procurement and use of such feedback 418.

The feedback 418 could further include information offered by or learned from trainees used to improve the training experience for future users. For example, during an intervention activity 412 that includes a simulation exercise, a trainee may come up with a novel solution to a simulation problem. The solution may be recorded by the training system 312 and then provided as feedback 418 to the system 200 as an additional or improved solution that can be incorporated into future training or incorporated into a process used in a real-time system, such as the system 100.

One goal of the functionality shown in FIGS. 2 through 4 is to tie training to an operator's competencies rather than to specific tasks. Various training programs can be used to train an operator to be proficient at a specific task. For example, training programs can be used to train an operator how to start up or shut down an industrial process or how to respond to an alarm. It is then assumed that an operator has desired competencies when the operator can complete specific tasks. Feedback is typically limited to whether or not each specific task can be completed.

The system 200 shown in FIG. 2 and its functionalities shown in FIGS. 3 and 4 operate to provide competency-based training and feedback instead of task-based training and feedback. The curricula defined by the competency model 304 and the intervention assets 307 identified by the library 306 are used to measure and help increase a trainee's competency to deliver various outcomes related to his or her job role and job responsibilities. As a result, the intervention assets 307 can be aligned and assigned based on trainee competencies and not merely whether the trainee can perform certain tasks.

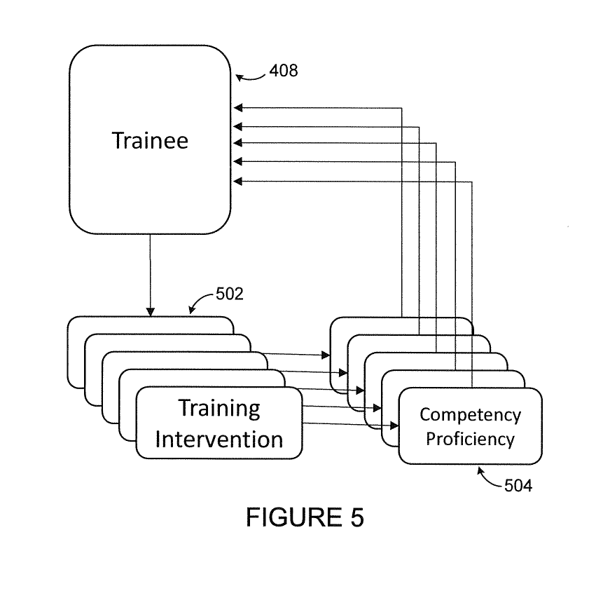

FIG. 5 illustrates the cyclical nature of how operator evaluation and training may occur. As shown in FIG. 5, the trainee 408 can undergo one or more training interventions 502, where each training intervention 502 involves one or more intervention activities 412 designed to increase the trainee's competency in some area. Each competency can be assigned one or more training interventions 502, and the same training intervention 502 may be assigned to more than one competency. Once completed, a measure of the trainee's proficiency 504 for one or more competencies can be generated and provided to the trainee 408. For example, the trainee's proficiency 504 at each competency could be expressed in terms of a “score” that identifies the proficiency level of the trainee that is attained at the end of each intervention. If necessary, additional training interventions 502 could then occur.

Although FIGS. 2 through 5 illustrate one example of a system for industrial process control and automation system operator evaluation and training, various changes may be made to FIGS. 2 through 5. For example, while described as being server-based or cloud-based, the system 200 could be implemented in other ways.

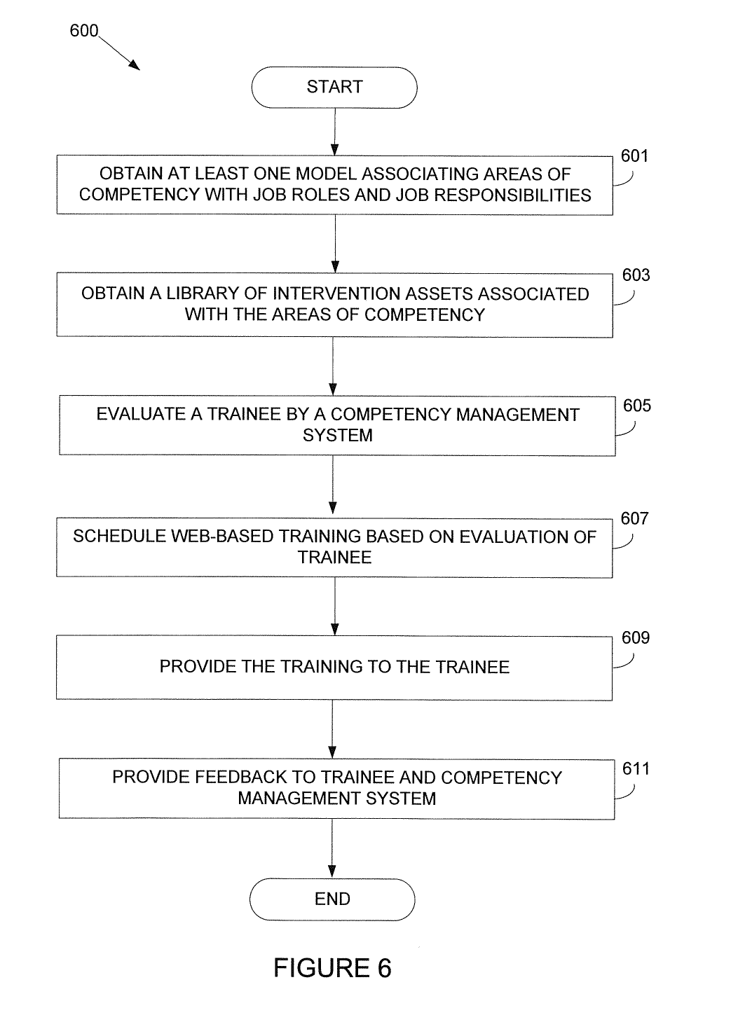

FIG. 6 illustrates an example method 600 for industrial process control and automation system operator evaluation and training according to this disclosure. For ease of explanation, the method 600 is described as being performed using the system 200 of FIG. 2. However, the method 600 could be used with any suitable device or system.

At step 601, at least one model associating areas of competency with job roles and job responsibilities of personnel is obtained. This could include, for example, the system 200 obtaining at least one curriculum competency model 304. The model could also associate the areas of competency with curricula of training exercises and content.

At step 603, a library of intervention assets associated with the areas of competency is obtained. This could include, for example, the system 200 obtaining the library 306 of intervention assets 307. The intervention assets include content for training personnel in at least one of the areas of competency as part of the curricula of training exercises and content.

At step 605, a trainee is evaluated by a competency management system. This could include, for example, the competency management system 406 evaluating a trainee 408 to determine a competency gap analysis 410 of the trainee 408. The competency gap analysis includes at least one competency gap associated with job responsibilities of the trainee. Each competency gap identifies at least one the areas of competency in which the trainee requires training.

At step 607, training for the trainee is scheduled. This could include, for example, the activity scheduler 414 scheduling the training by analyzing the competency gap analysis and identifying at least one intervention activity 412 for the training.

At step 609, the training is provided to the trainee. This could include, for example, the training system 312 providing web-based training to the trainee 408 based on the at least one competency gap. The training includes at least one of the intervention assets and at least one intervention activity.

At step 611, first and second feedback is provided in response to completion of the training. This could include, for example, the training system 312 providing feedback 416 to the trainee 408 and providing feedback 418 to the competency management system 406. The second feedback can be used by the competency management system to update the competency gap analysis of the trainee.

Although FIG. 6 illustrates one example of a method 600 for industrial process control and automation system operator evaluation and training, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs. In addition, while the method 600 is described with respect to the system 200 (which itself was described with respect to one or more industrial process control and automation systems), the method 600 may be used in conjunction with other types of devices and systems.

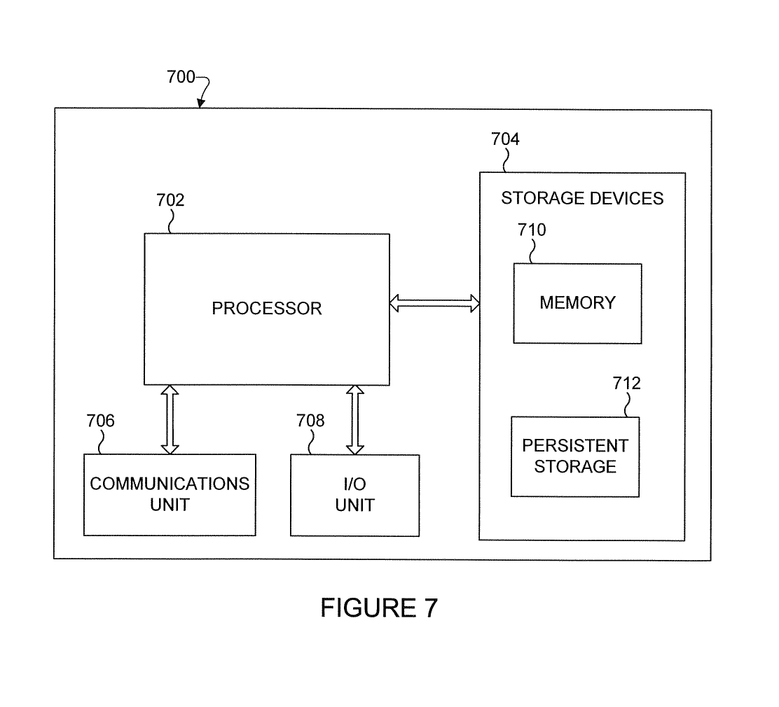

FIG. 7 illustrates an example device 700 supporting industrial process control and automation system operator evaluation and training according to this disclosure. The device 700 could, for example, denote various computing devices in the system 100 of FIG. 1 or the nodes, servers, or computing devices in the system 200 of FIG. 2. The device 700 could be used to perform one or more operations of the method 600.

As shown in FIG. 7, the device 700 includes at least one processor 702, at least one storage device 704, at least one communications unit 706, and at least one input/output (I/O) unit 708. Each processor 702 can execute instructions, such as those that may be loaded into a memory 710. Each processor 702 denotes any suitable processing device, such as one or more microprocessors, microcontrollers, digital signal processors, application specific integrated circuits (ASICs), field programmable gate arrays (FPGAs), or discrete circuitry.

The memory 710 and a persistent storage 712 are examples of storage devices 704, which represent any structure(s) capable of storing and facilitating retrieval of information (such as data, program code, and/or other suitable information on a temporary or permanent basis). The memory 710 may represent a random access memory or any other suitable volatile or non-volatile storage device(s). The persistent storage 712 may contain one or more components or devices supporting longer-term storage of data, such as a read only memory, hard drive, Flash memory, or optical disc.

The communications unit 706 supports communications with other systems or devices. For example, the communications unit 706 could include a network interface card or a wireless transceiver facilitating communications over a wired or wireless network (such as the network 204). The communications unit 706 may support communications through any suitable physical or wireless communication link(s).

The I/O unit 708 allows for input and output of data. For example, the I/O unit 708 may provide a connection for user input through a keyboard, mouse, keypad, touchscreen, or other suitable input device. The I/O unit 708 may also send output to a display, printer, or other suitable output device.

Although FIG. 7 illustrates one example of a device 700 supporting industrial process control and automation system operator evaluation and training, various changes may be made to FIG. 7. For example, various components in FIG. 7 could be combined, further subdivided, or omitted and additional components could be added according to particular needs. Also, computing devices can come in a wide variety of configurations, and FIG. 7 does not limit this disclosure to any particular configuration of computing device.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining at least one model associating areas of competency with job roles and job responsibilities of personnel, the at least one model also associating the areas of competency with curricula of training exercises and content;
obtaining a library of intervention assets associated with the areas of competency, the intervention assets comprising content for training personnel in at least one of the areas of competency as part of the curricula of training exercises and content;
evaluating a trainee, by a competency management system, to determine a competency gap analysis of the trainee, the competency gap analysis comprising at least one competency gap associated with job responsibilities of the trainee, the at least one competency gap identifying at least one of the areas of competency in which the trainee requires training; and
providing, by a training system, web-based training to the trainee based on the at least one competency gap, the training comprising at least one of the intervention assets and at least one intervention activity.

2. The method of claim 1, further comprising:
in response to completion of the training, providing, by the training system, first feedback to the trainee and providing second feedback to the competency management system, the second feedback configured to enable the competency management system to update the competency gap analysis of the trainee.

3. The method of claim 1, further comprising:
scheduling the training, by an activity scheduler, by analyzing the competency gap analysis and identifying the at least one intervention activity for the training.

4. The method of claim 1, wherein evaluating the trainee comprises providing at least one computer-based simulation of an industrial process to the trainee and receiving at least one response by the trainee.

5. The method of claim 1, wherein the trainee is one of personnel associated with an industrial process control and automation system.

6. The method of claim 1, wherein the areas of competency are based on an Abnormal Situation Management (ASM) Consortium competency model.

7. The method of claim 1, wherein the at least one model is hosted in a cloud-based network of computing devices.

8. An apparatus comprising:
at least one interface configured to exchange information over a cloud-based network; and
at least one processing device configured to:
obtain at least one model associating areas of competency with job roles and job responsibilities of personnel, the at least one model also associating the areas of competency with curricula of training exercises and content;
obtain a library of intervention assets associated with the areas of competency, the intervention assets comprising content for training personnel in at least one of the areas of competency as part of the curricula of training exercises and content;
control a competency management system to evaluate a trainee in order to determine a competency gap analysis of the trainee, the competency gap analysis comprising at least one competency gap associated with job responsibilities of the trainee, the at least one competency gap identifying at least one of the areas of competency in which the trainee requires training; and
control a training system to provide web-based training to the trainee based on the at least one competency gap, the training comprising at least one of the intervention assets and at least one intervention activity.

9. The apparatus of claim 8, wherein the at least one processing device is further configured to:
in response to completion of the training, control the training system to provide first feedback to the trainee and provide second feedback to the competency management system, the second feedback configured to enable the competency management system to update the competency gap analysis of the trainee.

10. The apparatus of claim 8, wherein the at least one processing device is further configured to:
control an activity scheduler to schedule the training by analyzing the competency gap analysis and identifying the at least one intervention activity for the training.

11. The apparatus of claim 8, wherein the at least one processing device is configured to evaluate the trainee by providing at least one computer-based simulation of an industrial process to the trainee and receiving at least one response by the trainee.

12. The apparatus of claim 8, wherein the training is for personnel associated with an industrial process control and automation system.

13. The apparatus of claim 8, wherein the areas of competency are based on an Abnormal Situation Management (ASM) Consortium competency model.

14. The apparatus of claim 8, wherein the apparatus comprises a computing device in a cloud-based network of computing devices.

15. A non-transitory computer readable medium containing instructions that, when executed by at least one processing device, cause the at least one processing device to:
obtain at least one model associating areas of competency with job roles and job responsibilities of personnel, the at least one model also associating the areas of competency with curricula of training exercises and content;
obtain a library of intervention assets associated with the areas of competency, the intervention assets comprising content for training personnel in at least one of the areas of competency as part of the curricula of training exercises and content;
control a competency management system to evaluate a trainee in order to determine a competency gap analysis of the trainee, the competency gap analysis comprising at least one competency gap associated with job responsibilities of the trainee, the at least one competency gap identifying at least one of the areas of competency in which the trainee requires training; and
control a training system to provide web-based training to the trainee based on the at least one competency gap, the training comprising at least one of the intervention assets and at least one intervention activity.

16. The non-transitory computer readable medium of claim 15, further comprising instructions that, when executed by at least one processing device, cause the at least one processing device to:
in response to completion of the training, control the training system to provide first feedback to the trainee and provide second feedback to the competency management system, the second feedback configured to enable the competency management system to update the competency gap analysis of the trainee.

17. The non-transitory computer readable medium of claim 15, further comprising instructions that, when executed by at least one processing device, cause the at least one processing device to:
control an activity scheduler to schedule the training by analyzing the competency gap analysis and identifying the at least one intervention activity for the training.

18. The non-transitory computer readable medium of claim 15, wherein the instructions that cause the at least one processing device to evaluate the trainee comprise instructions that cause the at least one processing device to provide at least one computer-based simulation of an industrial process to the trainee and receive at least one response by the trainee.

19. The non-transitory computer readable medium of claim 15, wherein the training is for personnel associated with an industrial process control and automation system.

20. The non-transitory computer readable medium of claim 15, wherein the areas of competency are based on an Abnormal Situation Management (ASM) Consortium competency model.
